(19) United States
(12) Patent Application Publication
(10) Pub. No.: US 2007/0047658 A1
(43) Pub. Date: Mar. 1, 2007

(54) Video comfort noise addition technique

(76) Inventors: Alexandros Tourapis, West Windsor, NJ (US); Jill MacDonald, Manalapan, NJ (US); Joan Llach, Princeton, NJ (US)

Correspondence Address: THOMSON LICENSING INC., PATENT OPERATIONS, PO BOX 5312, PRINCETON, NJ, 08543-5312, US

(21) Appl. No.: 10/572,690

(22) PCT Filed: Sep. 21, 2004
(86) PCT No.: PCT/US04/30745

§ 371 Date: Mar. 21, 2006

Related U.S. Application Data
(60) Provisional application No. 60/505,254, filed on Sep. 23, 2003.

(51) Int. Cl. H04N 11/02; H04B 1/66

(52) U.S. Cl. 375/240.25; 375/240.27

(57) ABSTRACT

A decoding arrangement for decoding pictures in an incoming video stream includes a noise generator for adding a dither signal containing random noise to the pictures after video decoding, to improve the subjective video quality. The noise generator adds noise to each pixel in an amount correlated to the luminance of at least a portion of the current picture.

### CROSS-REFERENCE TO RELATED APPLICATIONS

This application claims priority under 35 U.S.C. 119(e) to U.S. Provisional Patent Application Ser. No. 60/505,254 filed on Sep. 23, 2003, the teachings of which are incorporated herein.

### TECHNICAL FIELD

This invention relates to a technique for reducing artifacts in connection with decoding of a coded video stream.

### BACKGROUND ART

The decoding of a video stream compressed at low bit rate often yields visible artifacts noticeable to a viewer. Blockiness and structured noise patterns are common artifacts that arise when using block-based compression techniques. The human visual system has a greater sensitivity to certain types of artifacts, and thus, such artifacts appear more noticeable and objectionable than others. The addition of random noise to the decoded stream can reduce the noticeability of such compression artifacts, but large frame-to-frame differences created by adding random noise can itself produce artifacts that appear noticeable and objectionable.

The addition of a dither signal can reduce human sensitivity to image artifacts, for example to hide contouring and blocking artifacts. One prior art technique has proposed adding a random noise dither that is based on film grain to an image to disguise block effects. The rationale for adding such random noise is that random error is more forgiving than the structure, or correlated error. Other prior art techniques have proposed adding a dither signal to a video stream to hide compression artifacts. One past technique has proposed adding a random noise dither in the video encoding and decoding process in the in loop deblocking filter for the ITU/ISO H. 264 video coding standard, commonly known as the JVT coding standard. The amount of dither to be added depends on the position of a pixel with respect to a block edge. Another prior technique has proposed adding that random noise subsequent to video decoding (i.e., adding noise as a “post process”), for use as comfort noise. The amount of noise added depends on the quantization parameter and on the amount of noise added to spatially neighboring pixels. The term “comfort noise” comes from the use of noise in audio compression to indicate noise pattern generated at the receiver end to avoid total silence that is uncomfortable to a listener.

Past techniques for reducing artifacts by adding noise typically reduce spatial artifacts at the risk of creating temporal abnormalities, i.e., large frame-to-frame differences. Thus, there exists a need for a technique for reducing artifacts during decoding of a coded video stream that overcomes the aforementioned disadvantages.

### BRIEF SUMMARY OF THE INVENTION

Briefly, in accordance with a preferred embodiment of the present principles, a method is provided for reduced artifacts in a video stream during decoding. The method commences by decoding the video stream. Following decoding, noise is added to the video stream by adding noise to each pixel in an amount correlated to luminance of at least a portion of a previously decoded picture. Thus, in accordance with the present principles, luminance correlation aids in determining the additive noise to reduce large frame-to-frame differences, a disadvantage of prior noise additive techniques.

### BRIEF DESCRIPTION OF THE DRAWINGS

FIG. 1 depicts a block schematic diagram of a first embodiment of a video decoder arrangement in accordance with the present principles for reducing artifacts in connection with decoding a coded video stream by adding noise correlated to the luminance of at least a portion of the current picture;

FIG. 2 depicts a block schematic diagram of a second embodiment of a video decoder arrangement in accordance with the present principles for reducing artifacts in connection with decoding a coded video stream by adding noise correlated to the luminance of at least a portion of the current picture; and

FIG. 3 depicts a block schematic diagram of a third embodiment of a video decoder arrangement in accordance with the present principles for reducing artifacts in connection with decoding a coded video stream by adding noise correlated to the luminance of at least a portion of the current picture.

### DETAILED DESCRIPTION

In accordance with the present principles, adding a random-noise, containing dither signal, to already decoded signal, in an amount correlated to the luminance of at least a portion of a current picture, improves the subjective video quality.

Heretofore, adding noise to a decoded signal has been found to improve the quality of the video signal. The visual impact of adding a noise signal to the video sequence, rather than just to a single image, becomes a consideration in the determination of the magnitude of the noise signal. Consideration has been given to the visual impact of adding a noise signal to the video sequence, rather than just to a single image in the determination of the magnitude of the noise signal. The magnitude of additive noise signal for a pixel in a picture can be correlated to the value of the additive noise signal of the pixels in the previously displayed picture, e.g., the noise signals are temporally correlated. Alternatively, the temporal correlation can be based on the previously decoded picture, rather than the previously displayed picture.

Based on the foregoing, the added noise signal, using temporal correlation with a correlation factor α, 0≦α≦1, can be computed as
N(k,x,y)=(1−α)*N(k−1,x,y)+α*R(k,x,y) (1)
The random number R(k, x, y) can be generated using any type of random number distribution, for example a Normalized, Gaussian, or Laplacian distribution. R(k, x, y) may also be clipped within a certain range if necessary. The random number generator may be implemented by means of a lookup table. R(k, x, y) may also include spatial correlation, such as that used for example in film grain noise generation.

In accordance with present principles, noise addition appears quite dependent on the brightness (i.e., luminance) of a block or macroblock, but also to that of its adjacent blocks. The darker the block/macroblock, the easier it becomes to notice noise with relatively high variance. On this basis, the amount of additive noise N(k, x, y) can be given by the relationship:
N(k,x,y)=(1−γ(k,x,y))*N(k−1,x,y)+γ(k,x,y)*(1−φ(k,x,y))*R(k,x,y) (2)
with the function γ(k, x, y) representing a correlation factor dependent on the temporal correlation of the current image with the previous displayed or decoded one.
The term γ(k, x, y) can be computed as:
γ(k,x,y)=α−β*f₁(D(k,x,y),D(k−1,x,y)), 0≦β≦α≦1 (3)
where f₁( ) takes values between 0 and 1 and computes the temporal correlation factor of pixel (x, y) in picture k with its co-located pixel in picture k−1. The Factors α and β here relate to the picture type (I, P or B picture) as well as the quantizer used for coding the current picture or block, and can be calculated through the use of a lookup table. Alternatively, the full resolution difference image between pictures k and k−1, can be used and the two pictures may be considered as correlated (i.e. f₁=1) if the total absolute difference is below a value

It is also possible to consider simpler metrics. For example considerable savings in storage and computation can occur by considering the mean of N×N blocks instead and perform noise adaptation at a block level. In this case, the term f₁(D(k, x, y), D(k−1, x, y)) will equal:

$${f}_{1} ( D ( k , x , y ) , D ( k - 1 , x , y ) ) = ( \frac{1}{N \times N} abs ( {\sum }_{k = 0}^{N} {\sum }_{m = 0}^{N} D ( k , x + k , y + k ) - {\sum }_{k = 0}^{N} {\sum }_{m = 0}^{N} D ( k - 1 , x + k , y + k ) ) > {ζ}_{0} ? 0 \text{:} 1 ) \qquad ( 4 )$$

where 0≦ζ₀≦255.
The Term φ(k, x, y) reflects spatial information to adjust the strength of the noise that will be used. In particular φ(k, x, y) can be computed as:
φ(k,x,y)=f₂(D(k,x,y))+f₃(D(k,x−bsx,y),D(k,x+bsx,y),D(k,x,y−bsy),D(k,x,y+bsy)) (4)
where f₂( ) relates to the brightness of the current pixel or the N×N block to which it belongs, while f₃( ) computes the spatial relationship between the current pixel/block with it's horizontally or vertically adjacent at a distance of bsx or bsy. For example,

$$\begin{matrix}{f}_{2} ( D ( k , x , y ) ) = ( \frac{1}{N \times N} {\sum }_{k = 0}^{N} {\sum }_{m = 0}^{N} D ( k , x + k , y + k ) > {ζ}_{1} ? 0 \text{:} 1 ) & ( 5 ) \\ {f}_{3} ( D ( k , x , y ) ) = ( {f}_{2} ( D ( k , x , y ) ) - {f}_{2} ( D ( k , x + N , y ) ) = = {ζ}_{2} ) ∥ ∥ ( {f}_{2} ( D ( k , x , y ) ) - {f}_{2} ( D ( k , x - N , y ) ) = = {ζ}_{3} ) ∥ ∥ ( {f}_{2} ( D ( k , x , y ) ) - {f}_{2} ( D ( k , x , y + N ) ) = = {ζ}_{4} ) ∥ ∥ ( {f}_{2} ( D ( k , x , y ) ) - {f}_{2} ( D ( k , x , y - N ) ) = = {ζ}_{5} ) & ( 6 )\end{matrix}$$

where 0≦ζ₁≦255, and −255≦ζ₂, ζ₃, ζ₅≦255.

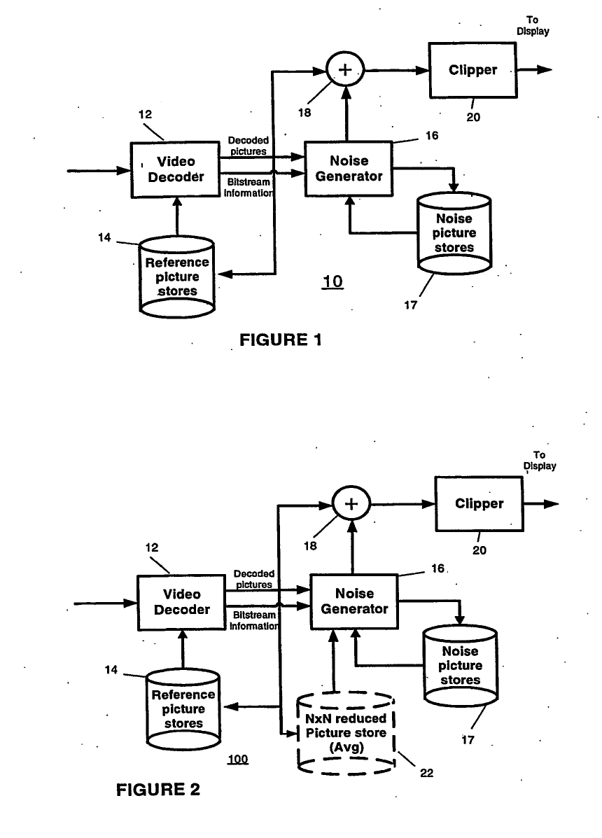

FIG. 1 depicts a block schematic diagram of a first embodiment of a video decoder arrangement 10 for adding noise correlated to the luminance of at least a portion of the current picture in a manner compatible with Equation 2 to reduce artifacts. The decoder arrangement 10 includes a decoder 12 for decoding an incoming coded video stream. The design of decoder 12 depends on the compression format employed to code the incoming video stream. In a preferred embodiment, the incoming video stream undergoes compression using the well-known ITU/ISO H. 264 standard. Under such circumstances, the decoder 12 takes the form of a H.264 decoder known in the art. A reference picture store 14 stores pictures decoded by the decoder 12 for use by the decoder in decoding future pictures.

The decoder 12 supplies a noise generator 16 with both a decoded picture, as well as bit stream information contained in the decoded picture. The bit stream information output by the decoder 12 can include a quantization parameter input to the noise generator. The severity of compression artifacts is correlated to the quantization parameter, with more severe compression artifacts occurring when high quantization parameter values are used. The strength of the added comfort noise can be increased as the quantization parameter value increases.

A summing block 18 sums each decoded picture from the decoder 12 with noise from a noise generator 16. A clipper 20 then clips the resultant signal output by the summing block 18 to yield a decoded picture for display which exhibits reduced artifacts. Note that noise addition occurs after storage of decoded pictures in the reference picture store 14 since the reference pictures must remain unchanged in order to properly decode the subsequent incoming pictures.

A noise picture store 17 stores the noise signal N(k, x, y) for the k^{th} picture for subsequent use by the noise generator 16. The noise generator 16 responds to reference pictures stored in the reference picture 14 store, which contains information about previously decoded pictures. Although not necessary, an additional storage could be added if block based computation for the temporal correlation between decoded pictures is used.

While noise generation for each pixel within an image remains possible, in certain cases (i.e. for higher resolution material), generation of larger size (grain) noise often proves more desirable. For example, applying an N×N block size Discrete Cosine Transform on the noise image, and then discarding the resultant higher frequencies will yield a larger size noise similar to film grain noise. This process nevertheless incurs a relatively large expense and typically will require a deblocking process in order to reduce blocking artifacts that might be generated on the block edges.

FIG. 2 depicts a block schematic diagram of a second embodiment of a video decoder arrangement 100 for adding large grain noise correlated to the luminance of at least a portion of the current picture. The decoder arrangement 100 includes many of the same elements as the decoder arrangement 10 of FIG. 1, and like reference numbers identify like elements. As compared to the decoder arrangement 10 of FIG. 1, the decoder arrangement 100 of FIG. 2 further includes a N×N reduced picture average store 22 coupled to the reference picture store 14. The picture store 22 typically stores N×N luma block average values. The average luma values stored in the picture store 22 allow the decoder arrangement to generate larger grain noise as discussed.

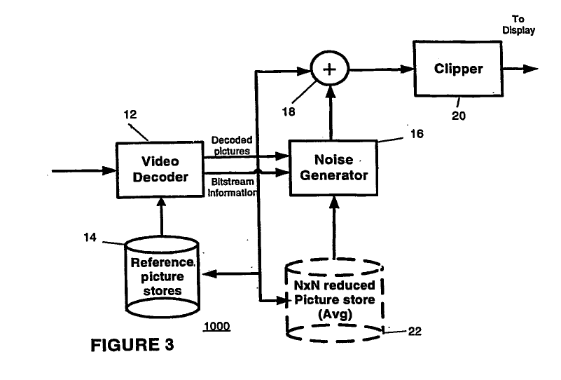

FIG. 3 depicts a block schematic diagram of a third embodiment of a video decoder arrangement 1000 for adding large grain noise correlated to the luminance of at least a portion of the current picture. The decoder arrangement 1000 of FIG. 3 includes many of the same elements as the decoder arrangement 100 of FIG. 2, and like reference numbers identify like elements. As compared to the decoder arrangement 100 of FIG. 2, the decoder arrangement 1000 of FIG. 3 contains no noise picture store 17, but only the N×N reduced picture average store 22.

An alternative and considerably simpler process would be to generate the noise at a smaller resolution than that of the original image (e.g. half horizontal and vertical resolution), and then up sample the noise (e.g. using sample replication). Using the original or smaller resolution could also be decided based on the resolution of the original pictures (e.g. use same resolution for Standard Definition and lower definition material, while using lower resolution noise generation for High Definition material). Side parameters could also be transmitted with the bit stream that would allow the decoder to decide which process shall be used. Side information could also be used for the generation of noise (e.g. noise variance weighting).

This exact same process could also be applied onto color components as well. Nevertheless, to reduce complexity and computation, noise generation could occur based only on one luminance component (i.e. luma), and while re-using the same noise on all color components, after performing a simple scaling and sub-sampling if necessary. For example, for 4:2:0 material, the luma noise is vertically and horizontally sub-sampled by 2, and can be divided by 2 in order to generate chroma noise.

The decoder arrangement 10 and 100 of FIGS. 1 and 2 represent instantiations of a temporal Infinite Impulse Response (IIR) filter. The IIR filter may be generalized by using more filter taps. IIR filters can also generally be approximated using higher order FIR filters, using as many taps, t, as desired in accordance with the following relationship:

$$N ( k , x , y ) = {\prod }_{j = 0}^{t - 1} ( 1 - γ ( k - j , x , y ) ) \times N ( k - t , x , y ) + {\sum }_{i = 0}^{t - 1} ( {\prod }_{j = 0}^{i - 1} ( 1 - γ ( k - j , x , y ) ) \times γ ( k - i , x , y ) \times ( 1 - ϕ ( k - i , x , y ) ) \times R ( k - i , x , y ) ) \qquad ( 7 )$$

A Finite Impulse Response (FIR) filter approach can be implemented using the decoder arrangement of FIG. 3. The decoder arrangement 1000 only makes use of the previous random numbers R, and if necessary, the N×N luma block mean values, rather than the previous noise N, in such an FIR filter approach, thus reducing memory bandwidth. It is possible also to use and store only the N×N luma block average values of the current and previous picture, and reuse the same values and their difference for all taps. For example we may use the following system:

$$N ( k , x , y ) = ( 1 - γ ( k , x , y ) ) \times ( 1 - γ ( k - 1 , x , y ) ) \times R ( k - 2 , x , y ) + ( 1 - γ ( k , x , y ) ) \times γ ( k - 1 , x , y ) \times ( 1 - ϕ ( k - 1 , x , y ) ) \times R ( k - 1 , x , y ) + γ ( k , x , y ) \times ( 1 - ϕ ( k , x , y ) ) \times R ( k , x , y ) \qquad ( 8 )$$

although it is further possible to simplify the above by forcing the difference images used in the computation of γ(k−1,x,y) to be the same as that of γ(k,x,y). This would completely avoid the need to store or re-compute the difference image, and considerably reduce memory bandwidth.

The foregoing describes a technique for reducing artifacts in connection with decoding of a coded video stream by adding noise correlated to the luminance of at least a portion of the current picture.

1. A method for reducing artifacts in a video stream, comprising the steps of:
decoding the video stream; and
adding noise to at least one pixel in a picture in the video stream following decoding in an amount correlated to luminance information of at least a portion of a current picture.

2. The method according to claim 1 further comprising the step of correlating the noise using a factor dependent on the temporal correlation of the current picture image with one of a previously displayed or decoded picture.

3. The method according to claim 2 wherein the correlation factor is established in accordance with one of a luma or color component.

4. The method according to claim 2 further comprising the step of adding noise to a color component of the picture in accordance with a luma component.

5. The method according to claim 2 wherein the correlation factor is first established on an N×N pixel picture block basis (where N is an integer) prior to interpolation of the additive noise.

6. The method according to claim 1 further comprising the step of adjusting the noise based on the intensity of an N×N block (where N is an integer) of adjacent pixels.

7. The method according to claim 1 wherein the amount of noise is correlated using an approximation of a Finite Impulse Response (IIR) filter.

8. A decoder arrangement for decoding a coded video stream to yield reduced artifacts, comprising:
a video decoder for decoding an incoming coded video stream to yield decoded pictures;
a reference picture store for storing at least one previously decoded picture for use by the decoder in decoding future pictures,
a noise generator noise for generating noise for addition to at least one pixel in a decoded picture in an amount correlated to correlated to luminance information of at least a portion of a current picture;
a noise picture store for storing the noise information for subsequent use by the noise generator.
a summing block for summing the noise generated by the noise generator with a decoded picture from the decoder; and
a clipper for clipping the summed noise and decoded picture.

9. The decoder arrangement according to claim 8 wherein the noise generator implements an instantiation of a Finite Impulse Response filter.

10. The decoder arrangement according to claim 8 wherein the noise generator implements an approximation of an Infinite Impulse Response filter.

11. The decoder arrangement according to claim 8 wherein the noise generator generates noise in accordance with decoded pictures and bit stream information supplied from the decoder.

12. The decoder arrangement according to claim 8 wherein the bit stream information comprises a quantization parameter.

13. The decoder arrangement according to claim 8 further including a second picture store for storing an N×N pixel block picture average, where N is an integer, for use by the noise generator.

14. A decoder arrangement for decoding a coded video stream to yield reduced artifacts, comprising:
a video decoder for decoding an incoming coded video stream to yield decoded pictures;
a reference picture store for at least one storing at least one previously decoded picture for use by the decoder in decoding future pictures,
a noise generator noise for generating noise in accordance with decoded pictures and bit stream information from the decoder for addition to at least one pixel in decoded in an amount correlated to additive noise of at least one pixel in a prior picture;
a picture store for storing an N×N pixel block picture average, where N is an integer, for use by the noise generator. a summing block for summing the noise generated by the noise generator with a decoded picture from the decoder; and

15. The decoder arrangement according to claim 20 wherein the noise generator implements an instantiation of a Finite Impulse Response filter.
